(19) United States
(12) Patent Application Publication
(10) Pub. No.: US 2023/0377513 A1
(43) Pub. Date: Nov. 23, 2023

(54) AN ARRANGEMENT FOR A THIN FILM ELECTROLUMINESCENT DISPLAY AND A METHOD FOR DRIVING A THIN FILM ELECTROLUMINESCENT DISPLAY

(71) Applicant: Lumineq Oy, Espoo (FI)

(72) Inventors: Mika Sirkiae, Espoo (FI); Jonne Lindeberg, Espoo (FI)

(21) Appl. No.: 18/247,062

(22) PCT Filed: Sep. 27, 2021
(86) PCT No.: PCT/FI2021/050632

§ 371 Date: Mar. 28, 2023

(30) Foreign Application Priority Data
Sep. 28, 2020 (FI) 20205935

(51) Int. Cl. G09G 3/32

(52) U.S. Cl. CPC G09G 3/32; G09G 2300/043; G09G 2310/0289; G09G 2370/22

(57) ABSTRACT

An arrangement and a method for a thin film electroluminescent display is disclosed. The arrangement comprises a thin film electroluminescent display panel, a driver electronics unit, and a high voltage node arranged to provide a supply of high voltage to the driver electronics unit. The arrangement also comprises a switch arranged between the high voltage node and the driver electronics unit. The method comprises a feeding step spanning a driving pulse period, in which one driving signal voltage pulse is fed to the display panel, and a dunking step such that the start of the dunking step and the end of the dunking step occurs at the end of the feeding step.

### FIELD OF THE INVENTION

The present invention relates to an arrangement for a thin film electroluminescent display (herein, referred to as a “TFEL”) and more particularly to an arrangement according to preamble of claim 1. The present invention further relates to a method for driving a TFEL and more particularly to a method according to preamble of claim 8.

### BACKGROUND OF THE INVENTION

TFELs are an important subtype among various display technologies. First TFELs date back to 1980s. These displays are robust, withstanding severe environmental conditions during usage and manufacture (e.g. placement into an industrial glazing laminate) and have excellent transparency characteristics. Recently transparent TFELs have emerged in optical applications, for example for the use case of showing information in the optical path of gunsights, telescopes and binoculars. Such applications are prone to handheld use cases, requiring almost always a battery powered operation.

TFELs are often classified as high-voltage devices as the luminescent output of the display is excited with a pulsed voltage with amplitudes reaching 200V or even more. TFEL light output is mostly determined by its thin-film composition and the colour of the light mostly by the dopants embedded in the phosphor layer. Most TFEL displays utilize the voltage level of 200V, but there are also thin film structures with a more modest light output at 80V level. In general, the higher the voltage, the more power can be converted into light, but the risk of an electric breakdown and the low availability of electrical components at high voltage levels becomes a major hurdle in such designs.

Generating for example a 200V high voltage from a DC battery with some 3-10V voltage available from a battery is readily achieved with e.g. chopper technologies. However, once the high voltage is achieved, a problem associated with the prior art is that leakage currents (=current leaking through the device constantly) and switching currents (current leaking through the device when the device changes a state, for example changes polarity in its high voltage outputs) become critical in the battery driven operations. This is because the level of power loss is directly proportional to the voltage level, or assuming a constant resistance over the load, even worse, proportional to the square of the voltage level. Such an increase in leakage and switching currents makes battery-based operations of TFELs challenging or even impossible if a miniaturized device volume of the display driving electronics and energy or power source is attempted. Thus, there is a need to improve the limiting of the leakage and switching currents in TFEL displays especially from the high-voltage supply to the display electronics.

### BRIEF DESCRIPTION OF THE INVENTION

An object of the present invention is to provide an arrangement for TFELs and a method for driving TFELs so that the prior art disadvantages are solved or at least alleviated.

The objects of the invention are achieved by an arrangement and a method characterized by what is stated in the independent claims 1 and 8, respectively. The preferred embodiments of the invention are disclosed in the dependent claims.

The invention is based on the idea of an arrangement for a thin film electroluminescent display, the arrangement comprising a thin film electroluminescent display panel comprising a segment electrode, a common electrode, a first insulation layer, a second insulation layer, a phosphor layer and a substrate. The arrangement also comprises a driver electronics unit is arranged to generate and supply a driving signal to the segment electrode and to the common electrode. The arrangement also comprises a common electrode connection for connecting the common electrode to the driver electronics unit, and a segment electrode connection for connecting the segment electrode to the driver electronics unit. The arrangement also comprises a high voltage node arranged to provide a supply of high voltage to the driver electronics unit. The driver electronics unit comprises a high voltage input node arranged to distribute the high voltage into the driver electronics unit. According to an aspect of the current invention, the arrangement comprises a switch. The switch is arranged between the high voltage node and the high voltage input node of the driver electronics unit. The switch comprises two states, an open state and a closed state. The advantage of the arrangement is that the high voltage node can be decoupled from the high voltage input of the driver electronics unit with the switch. Thus, the leakage current can be stopped entirely.

According to an embodiment, the driving signal comprises driving signal voltage pulses and driving pulse periods. One driving signal pulse occurs during one driving pulse period and two subsequent driving signal pulses are separated in time by one driving pulse period. One driving pulse period comprises a start and an end. The switch is arranged to be controlled during one driving pulse period first into the open state in which the switch is arranged to disconnect the high voltage node from the high voltage input node of the driver electronics unit during the driving pulse period, and then into the closed state in which the switch is arranged to connect the high voltage node to the high voltage input node of the driver electronics unit at the end of the driving pulse period. The advantage of this embodiment is that the high voltage node can be decoupled from and coupled back to the high voltage input of the driver electronics unit repeatedly so that the light production is minimally affected, yet minimising also leakage current.

According to an embodiment, the arrangement comprises a control unit and a switching control connection between the control unit and the switch, and the control unit is arranged to control the switch and set the state of the switch to the open state and to the closed state through the display switching control connection. A central control unit helps to reach an effective overall system architecture in the TFEL display.

According to an embodiment, the control unit is arranged into the driver electronics unit; or the switch is arranged into the driver electronics unit; or both the control unit and the switch are arranged into the driver electronics unit; or the control unit is arranged external to the driver electronics unit; or the switch is arranged external to the driver electronics unit; or both the control unit and the switch are arranged external to the driver electronics unit. All these arrangements are feasible alternatives for an effective display system architecture.

According to another embodiment, the control unit comprises a timing setting unit arranged to set, to the control unit, the time the control unit sets the state of the switch to the open state during a driving pulse period. It is advantageous to be able to set an appropriate length of the period the driving pulse period is without the high voltage supply.

According to an embodiment, the arrangement comprises a comparator unit arranged to sense an input current from the high voltage node to the high voltage input node of the driver electronics unit and communicate a disconnect signal to the control unit through a comparator-control connection as a response to the input current falling under a predetermined threshold current, and the control unit is arranged to set the state of the switch to the open state as a response to the disconnect signal.

Alternatively, as another way and method to utilize a comparator, the high voltage node comprises a voltage, and the arrangement comprises a comparator unit arranged to sense the voltage in the high voltage node and communicate a disconnect signal to the control unit through a comparator-control connection as a response to voltage of the high voltage node falling under a first predetermined threshold voltage, and the control unit is arranged to set the state of the switch to the open state as a response to the disconnect signal.

Alternatively, as yet another way and method to utilize a comparator, the high voltage node comprises a voltage, and the arrangement comprises a comparator unit arranged to sense the voltage in the high voltage node and communicate a disconnect signal to the control unit through a comparator-control connection as a response to voltage of the high voltage node rising above a second predetermined threshold voltage, and the control unit is arranged to set the state of the switch to the open state as a response to the disconnect signal.

With the arrangement comprising a comparator, it is possible to disconnect the high voltage supply dynamically on the right moment without needing to pre-set the time the high voltage is decoupled for the driving pulse.

According to yet another embodiment, the thin film electroluminescent display panel comprises one or more segment electrodes and more or more common electrodes, the driver electronics unit is arranged to generate and supply a driving signal to one or more segment electrodes and to one or more common electrodes, and the arrangement comprises: one or more common electrode connections for connecting the one or more common electrodes to the driver electronics unit, and one or more segment electrode connections for connecting the segment electrodes to the driver electronics unit. This embodiment makes a display with many segments possible.

According to an aspect of the present invention, a method for driving a thin film electroluminescent with driving signal voltage pulses to a segment electrode and to a common electrode of a thin film electroluminescent display is disclosed. Driving signal voltage pulses each have a driving pulse period. Driving signal voltage pulses are supplied with a driver electronics unit connected to a high voltage node with a switch. The method comprises:
a) a feeding step in which one driving signal voltage pulse is fed to a segment electrode and to a common electrode of a thin film electroluminescent display. The feeding step comprises a start of the feeding step and an end of the feeding step and the driving signal voltage pulse has a driving pulse period spanned by the start of the feeding step and the end of the feeding step.

The method also comprises a
b) a dunking step comprising a start of the dunking step in which the high voltage node is disconnected from the driver electronics unit with the switch by setting the switch to an open state, and an end of the dunking step, in which the high voltage node is connected to the driver electronics unit with the switch by setting the switch to a closed state. The start of the dunking step and the end of the dunking step span a dunking period, so that the start of the dunking step occurs during the driving pulse period and the end of the dunking step occurs at the end of the feeding step. Start of the dunking step and the end of the dunking step occur during the same feeding step, and thus during the same driving pulse period.

Advantage of the method is, just as with the arrangement discussed above that the leakage current to the control electronics unit can be minimized. Above, the concept of “dunking” means that the high voltage supply is dunked down for a dunking period, and then lifted back up.

According to an embodiment, in the method, the start of the feeding step, the end of the feeding step, the start of the dunking step and the end of the dunking step are triggered by a control unit. Control unit is advantageous as it makes the system architecture and synchronisation of the TFEL display elegant and robust. In the present application, “triggering” means the same as to “start instantaneously”.

According to an embodiment, in the method the start of the dunking step is triggered by the control unit when 5% of the driving pulse period has elapsed from the start of the feeding step; or the start of the dunking step is triggered by the control unit when 95% of the driving pulse period has elapsed from the start of the feeding step. A very long dunking step, e.g. when only 5% of the driving pulse period has elapsed, is very effective in limiting leakage currents in low brightness or low light output applications like optical applications. Similarly, when 95% of the driving pulse period is waited, high light output or high brightness is usually required.

The sooner, during a driving pulse period, the dunking step starts, the more leakage current can be eliminated.

According to an embodiment, the method comprises a disconnect signal sending step comprising a sending of a disconnect signal, said disconnect signal sent from a comparator unit to the control unit, comparator unit arranged to sense an input current from the high voltage node to the driver electronics unit, disconnect signal sending step triggered as a response to the input current falling under a predetermined threshold current, the dunking step triggered by the control unit upon the control unit receives a disconnect signal from the comparator unit. This embodiment makes it possible to monitor the current dynamically and determine when the light output for the driving pulse has subsided and the current flowing from the high voltage node to the driver electronics unit has a major and increasing leakage current component, thus mostly just wasting power in the TFEL display.

According to another comparator related embodiment, the method comprises a disconnect signal sending step comprising a sending of a disconnect signal, said disconnect signal sent from a comparator unit to the control unit, comparator unit arranged to sense the voltage of the high voltage node, disconnect signal sending step triggered as a response to the voltage of the high voltage node falling under a first predetermined threshold voltage, the dunking step triggered by the control unit upon the control unit receives a disconnect signal from the comparator unit.

According to yet another comparator related embodiment, the method comprises a disconnect signal sending step comprising a sending of a disconnect signal, said disconnect signal sent from a comparator unit to the control unit, comparator unit arranged to sense the voltage of the high voltage node, disconnect signal sending step triggered as a response to the voltage of the high voltage node rising above a second predetermined threshold voltage, the dunking step triggered by the control unit upon the control unit receives a disconnect signal from the comparator unit.

Above, the concept of “predetermined” in relation to “first predetermined threshold voltage” and “second predetermined threshold voltage” means that the threshold is determined e.g. to a fixed value, to a fixed value which is a ratio of another value, or a value which varies over time, but is predetermined before it is used in the determination related to the threshold, e.g. re-determined before every feeding step.

According to yet another embodiment, the feeding step comprises feeding a driving signal voltage pulse having a driving pulse period spanned by the start of the feeding step and the end of the feeding step to one or more segment electrodes and to one more common electrodes of the thin film electroluminescent display.

An overall advantage of the invention is that by switching off the high voltage supply to the display driver electronics unit for some time during a driving pulse feeding cycle, no leakage current can run during the period of the switch-off of the high voltage supply, that is, during the dunking period. During the switch-off or dunking period of the drive cycle with no high-voltage input available to the driver electronics unit, the (low voltage) voltage supply keeps the driving electronics running, however.

### BRIEF DESCRIPTION OF THE DRAWINGS

The invention is described in detail by means of specific embodiments with reference to the enclosed drawings, in which

FIG. 1 shows a prior art arrangement of a TFEL display,

FIG. 2 shows a prior art driving scheme for a TFEL display,

FIG. 3a shows a driving voltage behaviour related to the invention,

FIG. 3b shows the states of the switch related to the invention,

FIG. 4 shows an arrangement according to an embodiment of the current invention,

FIG. 5 shows an arrangement according to another embodiment of the current invention,

FIG. 6 shows a method, especially the timing scheduling of the method, according to an embodiment of the current invention,

FIG. 7 shows a method according to another embodiment of the current invention related to current based comparator utilization,

FIG. 8 shows a method according to another embodiment of the current invention related to voltage-based comparator utilization, and

FIG. 9 shows a method according to yet another embodiment of the current invention related to voltage-based comparator utilization.

### DETAILED DESCRIPTION OF THE INVENTION

In the following description, same labels (e.g. 184b) or same numbers (e.g. 126) denote same elements and features of the invention and its embodiments throughout the Figures.

Throughout this document, the word “connect” or “connected” means, unless otherwise specified, that the connected items are electrically connected with an intended, non-parasitic electrical connection. The concepts “voltage node” and “circuit node” are used interchangeably.

Throughout this document, the concept of “arrange between” two circuit nodes N1 and N2 means, unless otherwise specified, that the electrical component (e.g. a switch) has also at least two connecting nodes N3 and N4, and circuit node N1 is then coupled to N3 (so that the voltage in N1 and N3 is identical), and N2 to N4 (so that the voltage in N2 and N4 is identical), as more specifically defined in the associated description, claims and figures, so that an electric current may flow between nodes N3 and N4, as governed by the electrical component in question.

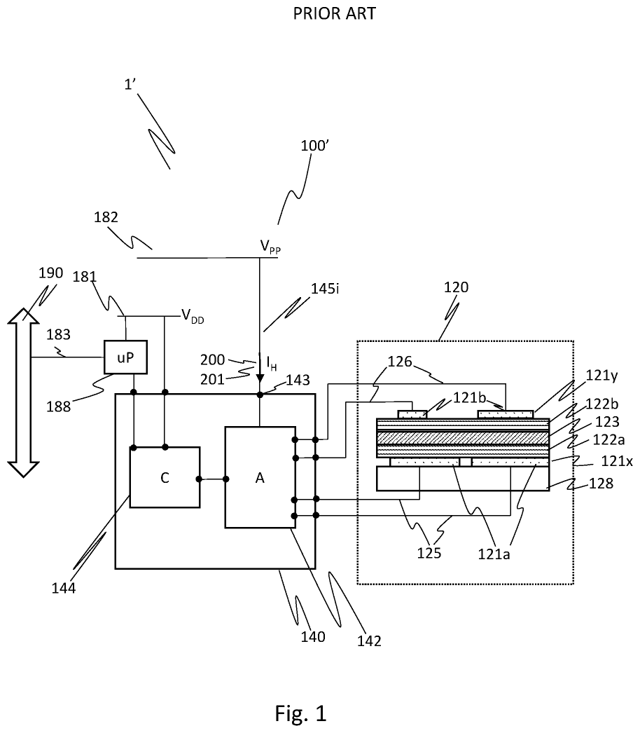

FIG. 1 shows schematically a prior art arrangement 1′ of a TFEL display 100′. The basic architecture of a TFEL display is usually partitioned into three major blocks, a TFEL display panel 120, a driver electronics unit 140, and a control unit 188.

In FIG. 1, as a schematic side cut-out view, the TFEL display panel 120 comprises usually a substrate 128 on which a thin film structure is deposited. The substrate may be a suitably transparent material like glass, e.g. soda-lime or aluminium silicate glass, or a ceramic material or a plastic which withstands the relatively high manufacturing process temperatures associated with the TFEL display manufacture.

The thin film structure comprises a first electrode layer 121x comprising common electrodes 121a. Common electrodes 121a may be manufactured e.g. by depositing an electrically conductive thin layer like an indium doped tin oxide layer on the substrate and then etching patterns on the conductive thin layer to provide electrodes and electrical connections or interconnecting traces coupling the driving voltage to the one or more common electrodes 121a from the contact area of the TFEL display panel 120 (contact area not shown in FIG. 1). Deposition of the indium doped tin oxide layer can be arranged e.g. with sputtering.

Suitable thicknesses of the indium doped tin oxide layer comprising the common electrodes is e.g. 350 nm, or a range between 300 nm-800 nm. The thicker the indium doped tin oxide layer, the more conducting the electrodes and interconnecting traces are, but the less transparent and optically clear the layer also is.

On top of the common electrodes 121a, a first electrically insulating layer or a second dielectric layer is deposited 122a. Purpose of this layer is to stop a direct current from running over the thin film stack, as this kind of current would be very strong and likely destroy the structure. The dielectric layer 122a is preferably deposited with an atomic layer deposition method as the requirements of the pin-hole free nature of the film are very high due to the risk of an electric breakdown. Also transparency is a key feature. One suitable combination of materials for the dielectric layer 122a is a nano-laminate (a stratified thin-film stack) of aluminium oxide and titanium oxide, having excellent electrically insulating qualities.

On top of the electrically insulating layer or a dielectric layer 122a, a phosphor layer 123 is deposited. This layer is the luminescent layer capable of light production, owing to hot electrons colliding with dopant atoms, excited in motion with the high voltage (and thus, high electric field between the thin films). Suitable materials for phosphor layer are e.g. ZnS:Mn or ZnS:Tb (manganese or terbium doped zinc sulfide) for primarily yellow and green light outputs, respectively. Atomic layer deposition (“ALD”) is an advantageous method for depositing the phosphor layer 123.

In other words, the phosphor layer 123 may be deposited with the atomic layer deposition method.

Thickness of the phosphor layer 123 may be 100 nm-2000 nm, more preferably 200 nm-1000 nm or most preferably 500 nm-900 nm.

On top of the phosphor layer 123, a second electrically insulating layer or a second dielectric layer 122b is deposited. In composition and in the way the layer is arranged, this layer 122b may be identical to the layer 122a, and its purpose is the same as with layer 122a.

Finally, on top of the second electrically insulating layer, one or more segment electrodes 121b and interconnecting traces are arranged on the second electrode layer 121y. As with common electrodes, one or more segment electrodes 121b may be arranged by first depositing a conductive thin layer, e.g. a layer of transparent, yet electrically conductive indium doped tin oxide on top of the second dielectric layer, and then etching and masking suitable patterns on the second electrode layer.

Thus, a segment electrode 121b and a common electrode 121a, when overlapping in a lateral extension defined by the surface of the substrate, form a plate capacitor that has a non-ideal insulator between capacitor plates owing to the hot electron excitation. Said hot electron excitation, when electrons collide with the dopant atoms of the phosphor layer 123, give rise to the light output.

Common electrodes 121a are called “common” because they may serve a group of segment electrodes 121b overlapping the common electrodes 121a. It is possible to provide only one common electrode 121a to the TFEL display panel 120. Alternatively, every segment electrode 121b may have its dedicated common electrode 121a. The electrodes may naturally be placed in any orientation or shape, e.g. comprise finger like rows and columns, resulting in a passive matrix TFEL. As said, light production occurs where segment and common electrodes overlap, and a suitably high voltage is applied from segment electrode to common electrode in an alternating or pulsed fashion. This type of display is commonly called the AC (alternating current) TFEL. A suitable voltage pulse amplitude from segment to common electrode can be e.g. 200V or −200V. In the negative case, the 200V voltage is applied to the common electrode, and the segment electrode is held at a zero potential. To turn off light, the voltage difference must be lowered below a light emission threshold voltage, to a level of 120V-140V. Of course, at 0V voltage difference, no light output occurs. Thus, for no output in a segment/common electrode overlap, segment electrode can be held at 0V and common electrode can be held at 0V. Respectively, for no light output, in a segment/common electrode overlap, segment electrode can be held at 200V and common electrode can be held at 200V, resulting in a 0V voltage difference. The shape of the light producing area like a symbol or pixel (square picture element in matrix displays) is thus defined by the shape of the segment and common electrode overlap as this defines the area or shape where hot electron excitation and travel occurs, perpendicular to the surface of the thin film structure.

Electrode connections, specifically one or more common electrode connections 125 and one or more segment electrode connections 126, are arranged to provide the electrical connections between the driver electronics unit 140 and the TFEL display panel 120 and specifically the one or more common electrodes 122a and the one or more segment electrodes 122a in the TFEL display panel 120, respectively. The one or more common electrode connections 125 and the one or more segment electrode connections 126 may comprise conductive traces on the first and second electrode layers 121x and 121y, respectively, cablings like flexible printed circuits (FPCs), electrical connectors like lead frame connectors, mating connectors, solders, bonded structures, or one or more connecting pad areas, or any combination thereof in a series or parallel electrical connection.

Turning to unit 140 in FIG. 1, a driver electronics unit 140 is depicted schematically. Purpose of the driver electronics unit 140 is to provide driving signals to the TFEL display panel 120 so that at any one time, a desired combination of the segments or pixels is lit on the display, said segments and pixels defined by the overlapping areas of segment and common electrodes. For this end, the driver electronics unit comprises a high voltage unit 142 for driving signal generation and a low voltage unit 144 for the internal control e.g. of the high voltage unit 142 inside the driver electronics unit 140. Units arranged to perform all or most of the functionality of the driver electronics unit 140 are readily available commercially. One example is the HV509 chip available from Supertex Inc. or Microchip Inc. The HV509 chip is a 16-channel serial to parallel converter with a high voltage backplane driver and push-pull outputs capable of 200V, 16 channel output. Several HV509 chips can be cascaded for the output of over 16 channels. Herein, one channel means one segment electrode connection 126 paired with a common electrode connection 125.

Further, driver electronics unit 140 is arranged to be controlled with a control unit 188. Control unit 188 may comprise a microprocessor, a micro controller, an ASIC or an FPGA chip that is arranged to control the driver electronics unit 140 based on the input received from an information signal connection 183, connected to some interface or communications bus 190 so that the TFEL display 100 may show the output it is arranged to show based on the information in the interface or communications bus 190. The communications bus 190 may be e.g. a CanBUS bus carrying data on the speed of a vehicle the TFEL display 100 is arranged into. The TFEL display 100 may comprise three seven-segment display patterns on the TFEL display panel 120. Control unit 188 may be arranged to interpret the message in the CanBUS containing the speed information, and turn on (make emit light) and turn off (remain dark) certain segments of the three seven-segment display patterns so that the information on speed (in units like km/h) is shown to the user of the TFEL display. Alternatively, the communications bus 190 may be a data interface of an aiming system of a firearm, and the three seven segment display patterns are arranged to show the distance information to the aiming point of the aiming system in the optical path of the aimscope of the aiming system, said distance information supplied by the communication bus 190 and provided with other dedicated units of the aiming system. Still alternatively, the control unit 188 may self-generate all or most of the information shown on the TFEL display 100, e.g. when the display 100 performs the functions of a clock showing time.

Finally, the prior art TFEL display 100′ comprises two voltage nodes, a supply voltage node 181 (V_{DD}) and a high voltage node 182 (V_{PP}). Voltage of the supply voltage node 181 may be e.g. from 1.5V to 12V. Voltage of the high voltage node 182 may be e.g. 80V-220V, or 190V-205V. Voltage to the voltage nodes 181 and 182 may be generated inside the TFEL display 100 with voltage conversion technologies like choppers, DC-AC-converters, DC-DC-converters, AC-DC-converters and transformers, or the voltage may be supplied to the TFEL display 100 from external sources.

The driver electronics unit 140 is supplied with the high voltage from the high voltage node 182 through a high voltage connection 145i. High voltage connection 145i carries the input current 200 and the loss current 201, jointly denoted as I_{H}. In prior art solutions, control of the loss current 201 has been challenging. Because of the high voltage V_{PP} involved, a power loss P_{W} due to the loss current 201 (I_{L}) is high, P_{W}=V_{PP}×I_{L}, that is, the power loss is directly proportional to the voltage level of the high voltage node, quickly depleting batteries for any battery-operated arrangement involving a prior art TFEL display.

As discussed above, the loss current comprises two elements wasting power in the arrangement according to FIG. 1. The elements are:
leak current which is a current leaking through the device constantly or with a small variation over time, and
switching current which is a current flowing through the device when the device changes a state, in particular when the polarity of the driving signal pulse train, that is, the voltage sensed by the capacitor comprising the overlap of a segment electrode and a common electrode is arranged to be changed from positive to negative and vice versa.

It is important to note that the driver electronics unit is supplied for the control and logical operations with a (low) supply voltage node 181 which is separate to the high voltage supply node 182.

Throughout the present application, as is evident, every voltage node (also called a circuit node) like a node marked with label 143, 181, 182 or 145c may have a voltage when the arrangement is operating. Similarly, between any two voltage nodes or circuit nodes, a current may run as governed by the circuit element or a connection of circuit elements between the two circuit nodes.

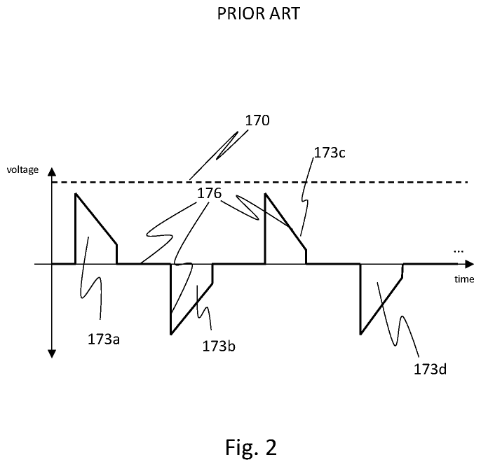

Turning to FIG. 2, a prior art driving voltage time behaviour is shown when a driving signal is fed to a segment electrode overlapping, at least partially, a common electrode and constituting essentially a capacitive load with a resistive, nonlinear component due to the hot electron related light production. The driving voltage comprises a stream of voltage pulses (four pulses, 173a, 173b, 173c and 173d are shown but naturally pulses with a suitably high voltage amplitude are being fed as long as the segment-common electrode overlap is to produce light) that are fed to a segment electrode and to a common electrode with which the segment electrode overlaps at least partially. Specifically, the voltage is between two electrodes, a segment electrode and a common electrode. Lower limit for the pulse frequency, also called the driving frequency, is set by the sense of vision as too slow (low) driving is sensed as flickering in the light emitted by the overlapping areas of the segment and common display electrodes. Usually a minimum frequency is 50 Hz. Practical upper limits for the driving frequency is in the range of 500 Hz-4000 Hz, imposed by the charging time t_{C} of the capacitive load (C) over the resistive conductive layer traces R_{S}, t_{C}=R_{S}C. As known, driving pulse frequency can be used to set the brightness of the display as perceived by the sense of vision because the perceived brightness is directly proportional to the driving pulse frequency.

Owing to the charge build-up in the electrodes, it is customary to drive the TFEL display with alternating pulse polarities as the built-up charge of the previous driving pulse fed to the common electrodes intensifies the light output. This kind of polarity alternation is stated in FIG. 2 by a positive pulse 173a, followed by a negative pulse 173b, then a positive pulse 173c, and a negative pulse 173d. This sequence continues as long as the segment electrode overlapping the common electrode is to produce light (that is, when the overlapping areas it is to be turned on). FIG. 2 also shows that the driver electronics unit 140 is arranged to operate with a single high voltage supply and voltage level 170. Such operation is called a differential mode of operation. In other words, the driver electronics unit 140 is arranged to switch the polarity of the segment-common electrode terminals (to which the common electrode connection 125 and the segment electrode connection 126 are coupled) e.g. after every pulse.

In the situation of FIG. 2, the high voltage supply is held constantly at a high voltage level 170 (shown with a dashed line), causing a leakage current related power loss owing to the power loss being at least minimally directly proportional to the voltage of the high voltage supply.

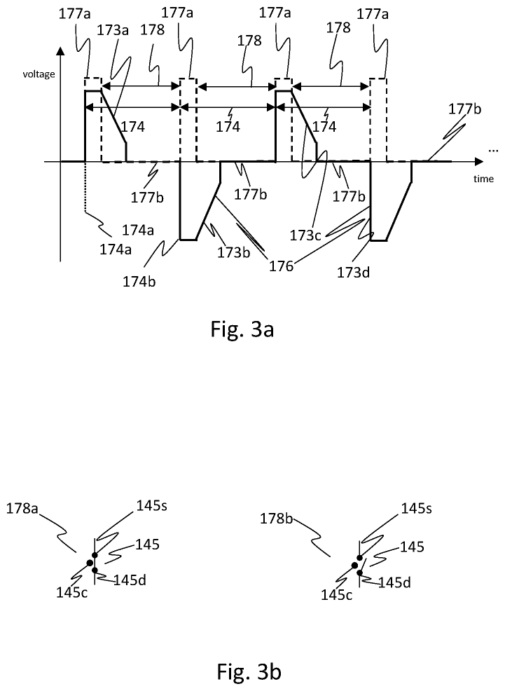

FIG. 3a shows the basic principle of the current invention, a time axis of a driving voltage behaviour or driving signal 176 as experienced by one segment electrode-common electrode overlapping area, positive polarity defined e.g. from the segment electrode to the common electrode. In contrast to FIG. 2, the high voltage supplied to the driving electronics is not held on a steady high level, as in FIG. 2, but supplied intermittently, from the beginning or start 174a of the driving pulse period 174 for some time into the driving pulse period 174 (shown as the high voltage on state 177a), and then turned off (showed as the high voltage off state 177b). Driving pulse period 174 ends at a driving pulse period end 174b, after which the next driving pulse period 174 immediately starts at the start 174a of the next driving pulse period 174. During the high voltage off state, no current or only an insignificant leakage current can run from the high voltage node 182 of FIG. 1 as the voltage over the driver electronics unit 140 is essentially zero. However, the high voltage of the high voltage node 182 is connected to the driver electronics unit 140 for a suitably long period of time that allows light production during the high voltage on states 177a. Thus, during time periods 178, the high voltage node 182 is turned off (e.g. with a controllable switch), marked by the high voltage off states 177b, and then turned back on for the next driving pulse period 174 to occur. FIG. 3a shows four driving pulses 173a-173d. Again, as in FIG. 2, in FIG. 3a the driving voltage pulse 173a-173d polarity is shown from the segment electrode to the common electrode as driver electronics unit 140 is arranged to supply the pulses in alternating polarities. Thus, a high voltage 177a applied to a common electrode and a zero voltage applied to the segment electrode is illustrated as negative pulses 173b and 173d below the time axis. However, this does not change the way the high voltage is supplied, thus explaining why high voltage on state 177a remains positive during every driving pulse 173a-173d as shown in FIG. 3a.

FIG. 3b illustrates the states of a switch 145 relevant to the current invention. In a closed state 178a, the circuit nodes 145s and 145d are connected with no or with only a very low impedance, ideally becoming short circuited. In an open state 178b, the circuit nodes 145s and 145d have a large or infinite (open circuit) impedance between them. State of the switch 145 is arranged to be controlled with control circuit node 145c both states of the switch. The switch 145 may hold its state when no control signal is present and change the state when a control signal or impulse is sent to the control circuit node 145c. Alternatively a voltage level or a current input at control circuit node 145c may arrange the switch 145 into an open state 178b, and another voltage level or another current input in at the control circuit node 145c may arrange the switch 145 into the closed state 178a.

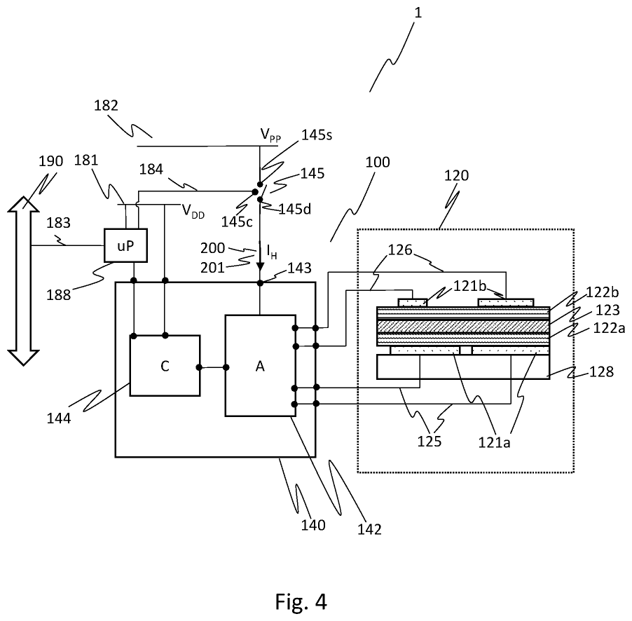

Turning to FIG. 4, as an aspect of the present invention, an arrangement 1 for a thin film electroluminescent display 100 is shown. The arrangement 1 comprises a thin film electroluminescent display panel 120 comprising a segment electrode 121b, a common electrode 121a, a first insulation layer 122a, a second insulation layer 122b, a phosphor layer 123 and a substrate 128. Thus, the display panel 120 can be considered as the information showing part or “glass” part of the display 100 that can be arranged, for example, to a frame, inside a laminate especially if the parts of the panel 120 are arranged to be transparent, or inside an optical device like a telescope or a gunsight, especially into an optical path of an optical device.

The structure, the composition and the methods of manufacture for the thin film electroluminescent display panel 120 are already discussed in conjunction in FIG. 1 above.

In particular, the phosphor layer 123 may be deposited with the atomic layer deposition method.

Thickness of the phosphor layer 123 may be 100 nm-2000 nm, more preferably 200 nm-1000 nm or most preferably 500 nm-900 nm.

The arrangement 1 also comprises a driver electronics unit 140 arranged to generate and supply a driving signal 176 to the segment electrode 121b and to the common electrode 121a. Naturally, the electrodes of the display panel 120 must be connected electrically to the electronics unit 140. Thus, a common electrode connection 125 is arranged for connecting the common electrode 121a to the driver electronics unit 140, and a segment electrode connection 126 is arranged for connecting the segment electrode 121b to the driver electronics unit 140. A high voltage node 182 is also arranged to provide a supply of high voltage to the driver electronics unit 140. For this end, the driver electronics unit 140 comprises a high voltage input node 143 arranged to distribute the high voltage into the driver electronics unit 140.

According to an aspect of the invention, the arrangement 1 comprises a switch 145. The switch 145 is arranged between the high voltage node 182 and the high voltage input node 143 of the driver electronics unit 140. Purpose of the switch is to facilitate the intermittent supply of the high voltage of the high voltage node 182 to the driver electronics unit 140. To this end, the switch 145 comprises two states, an open state 178b and a closed state 178a. The switch 145 is preferably an electrically controllable switch that changes its state between an open state and a closed state by a control command (a so-called toggle command), or alternatively assumes an open state or a closed state when the switch 145 receives a control signal containing the respective command in an analogue or digital format. Alternatively, the switch 145 may be a free-running switch that changes its state between an open state 178b and a closed state 178a repeatedly based on controls of its internal clock or oscillator unit.

Referring to FIGS. 3a and 4, in an embodiment, the driving signal 176 comprises driving signal voltage pulses 173 and driving pulse periods 174. Voltage polarity of the voltage pulses 173 is defined as the voltage between a segment electrode and a common electrode. One driving signal pulse occurs during one driving pulse period 174, and two subsequent driving signal pulses 173 are separated in time by the driving pulse period 174, as shown in FIG. 3a. Also as shown in FIG. 3a, one driving pulse period comprises a start 174a and an end 174b. The switch 145 is arranged to be controlled during one driving pulse period 174 first into the open state 178b in which the switch 145 is arranged to disconnect the high voltage node 182 from the high voltage input node 143 of the driver electronics unit 140 during the driving pulse period 174. Then, after the switch is arranged to be controlled into the open state 178, the switch 145 is arranged to be controlled into the closed state 178a in which the switch 145 is arranged to connect the high voltage node 182 to the high voltage input node 143 of the driver electronics unit 140 at the end of the driving pulse period 174. Next driving pulse period begins immediately after the driving pulse period 174 ends. Thus, the end of the driving pulse period 174 is occurs immediately before the start of the next driving pulse period. In the start of the driving pulse period 174, the driving pulse feeding to the common electrode connections 125 and segment electrode connections 126 commences and the absolute value of the voltage rises very rapidly towards the light producing levels over the thin film structure of the TFEL panel 120.

As illustrated in FIG. 4, in an embodiment, the arrangement 1 may also comprise a control unit 188 and a switching control connection 184 between the control unit 188 and the switch 145, and the control unit 188 is arranged to control the switch 145 and set the state of the switch 145 to the open state 178b and to the closed state 178a through the display switching control connection 184.

Control unit 188 may be e.g. a microprocessor or a microcontroller, or an FPGA or ASIC circuit, or a dedicated computer system. Control unit 188 may comprise software code or logical functions arranged permanently to the control unit 188, arranged to perform control functions for e.g. communicating with the systems external to the display 100, such systems shown in FIG. 4 with a communications bus 190 like a CanBUS or RS485 bus. Communications bus 190 may also be a communication interface like I2C or SPI. Control unit 188 is connected to the communication bus 190 or communication interface 190 with an information signal connection 183 arranged to carry relevant electrical information into and out of the TFEL display 100.

Similarly, control unit 188 may be arranged to control the low voltage unit 144 of the driver electronics unit 140 for the purpose of displaying of information, that is, which segment-common electrode overlapping areas are to be turned on with the driving signal pulses at any one time, and which are to remain dark, that is, not driven with a driving signal pulses or driven with driving signal pulses having too low amplitude for light production. For example in a thin film structure driven with pulses having 200V amplitude, a so-called light emission threshold voltage for light production is approximately 140V and thus any amplitude for driving pulses below 140V does not produce light.

Control unit 188 is may also be arranged to control the switch so that the operation of the switch 145 repeatedly into the closed state and into the open state is synchronized with the driving signal pulse generation for the TFEL display panel 120. For this end, a switching control connection 184 is arranged into the arrangement 1. Specifically, the switch may comprise three voltage nodes, a control node 145c for setting the state of the switch, a supply side node 145s for connecting the switch to the high voltage node 182 and a device side node 145d to connect the switch to the driver electronics unit 140. The device side node 145d may be specifically connected to the high voltage unit 142 of the driver electronics unit 140. Switch 145 may comprise e.g. a PMOS and NMOS field effect transistors and other known discrete or integrated electronics components arranged so that the switch 145 goes to the closed state (that is, the “on” state, where there is a low or no impedance between the device side node 145d and supply side node 145s) when a supply voltage (e.g. 5V) is applied to the control node 145c and enters a closed state (that is, “off” state where there is a high or an infinite impedance between the device side node 145d and supply side node 145s) when a zero voltage is applied to the control node 145c. It is evident, looking at FIG. 4, that the impedance state between the nodes 145s and 145d determines if the switch conducts electricity from the high voltage node 182 to the driver electronics unit 140 or not.

In an embodiment, the control unit 188 may be arranged into the driver electronics unit 140. It is quite feasible to construct a dedicated integrated circuit (“IC”) to arranged to perform the functions of the control unit 188 and the driver electronics unit 140.

Similarly, in an embodiment, the switch 145 may be arranged into the driver electronics unit 140. Again, it is straightforward to construct e.g. a dedicated integrated circuit to arranged to perform the functions of the switch 145 and the driver electronics unit 140.

In yet another embodiment, both the switch 145 and the control unit 188 are both arranged into the driver electronics unit 140. An IC arranged to perform the functions of the control unit 188, the switch 145 and the driver electronics unit 140 is readily arranged e.g. by application specific integrated circuit (ASIC) technologies and design methods.

In still another embodiment the control unit 188 is arranged external to the driver electronics unit (140). ICs that offer most of the functionality or all of the functionality of the driver electronics unit 140 are readily available. One example is the above-mentioned HV509 chip.

In an embodiment the switch 145 is arranged external to the driver electronics unit 140. Especially if the display is large, its electrodes need strong charging currents, and thus the switch 145 may heat up, and in this case it is advantageous to place the switch 145 external to the driver electronics unit 140.

In yet another embodiment both the control unit 188 and the switch 145 are arranged external to the driver electronics unit 140. This embodiment makes it easy to use off-the-shelf components for the arrangement 1, but on the other hand more area is needed e.g. from the circuit board to facilitate the various connections between the component and mechanical support for the components.

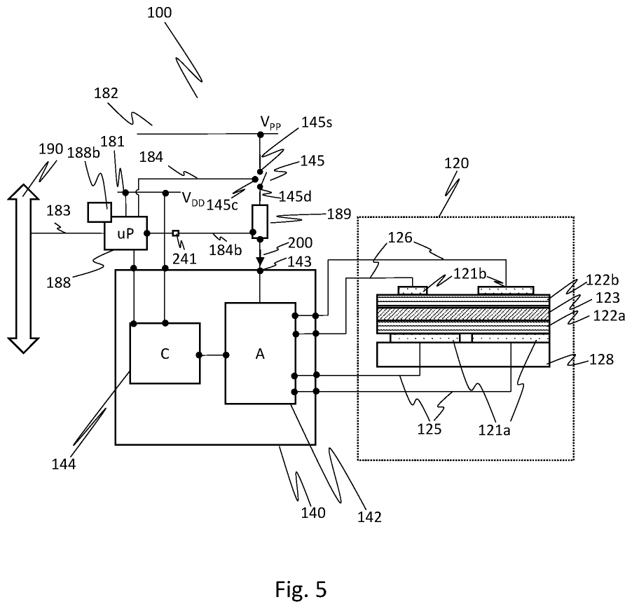

As shown in FIG. 5, as an embodiment, in the arrangement 1 the control unit 188 may comprise a timing setting unit 188b arranged to set, to the control unit 188, the time t_{d} the control unit 188 sets the state of the switch 145 to the open state 178b during a driving pulse period 174. It is customary that the driver electronics unit 140 needs to be adjusted according to the design of the TFEL display panel 120 as the capacitive loads of the various segment/common electrodes can vary greatly. Thus, the possibility to adjust or set the moment of time, in a driving pulse period 174, the high voltage node 182 is disconnected from the driver electronics unit 140 is advantageous. The timing setting unit 188b may comprise an electric component like a trimmer potentiometer arranged to supply the timing information to the control unit 188. Alternatively, the unit may be arranged through software or logical circuit means to govern the operation of the control unit 188. The time the control unit 188 sets the state of the switch 145 to the open state 178b during a driving pulse period 174 may be set as a ratio of the time elapsed from the start of the driving pulse period 174 relative to the length of the entire driving pulse period 174, or as an absolute value, e.g. t_{d}=1 ms if the length of the driving pulse period 174 is e.g. 4 ms. As a ratio, this would be 1 ms/4 ms=25%.

Referring still to FIG. 5, as an embodiment, the arrangement 1 may comprise a comparator unit 189 arranged to sense an input current 200 from the high voltage node 182 to the high voltage input node 143 of the driver electronics unit 140 and communicate a disconnect signal 241 to the control unit 188 through a comparator-control connection 184b as a response to the input current 200 falling under a predetermined threshold current 202. The control unit 188 may also be arranged to set the state of the switch 145 to the open state 178b as a response to the disconnect signal. The embodiment of FIG. 5 is advantageous as the input current 200 indicates the charging status of the display electrodes of the TFEL display panel 120. In the early phases of the driving pulse, when the voltage increases between a pair of segment/control electrodes during one driving pulse, also a strong current flows, and when the light emission threshold voltage is reached between the electrodes, light emission starts, lasting a light pulse period. When the light pulse period comes close to its end, current flowing to TFEL display panel 120 starts to decrease, also manifested in the decrease in the input current 200. Thus, there is a threshold current 202 after which the power taken from the high voltage node 182 does not contribute much to the light output, and it is advantageous to disconnect the high voltage node 182 altogether with the switch 145 to avoid the leakage current from the high voltage node 182 into the driver electronics unit 140.

As is evident from the circuit topology of FIG. 5, the comparator unit 189 may be arranged between the device side node 145d of the switch and the high voltage input node 143 of the driver electronics unit 140 (as shown) or between the supply side node 145s of the switch and the high voltage node 182 as the same current 200 flows through in either case (the comparator-control connection 184b is only arranged for signal-passing purposes and carries no or only an insignificant current from the high voltage node 182). The comparator 189 can also be arranged over the switch 145, between the supply side node 145s and to the device side node 145d. This is because the switch, even in the open state, may have a small resistance or impedance between the nodes 145s and 145d, causing a small voltage drop Vts from node 145s to node 145d. Comparator 189 can be arranged to sense the voltage drop Vts, thereby also sensing the input current 200 from the high voltage node 182 to the high voltage input node 143 of the driver electronics unit 140.

It is also possible to arrange the comparator to be based on voltage sensing of the high voltage node 182. In an embodiment, in the arrangement, the high voltage node 182 comprises a voltage. The arrangement 1 comprises a comparator unit 189 arranged to sense the voltage in the high voltage node 182 and communicate a disconnect signal to the control unit 188 through a comparator-control connection 184b as a response to voltage of the high voltage node 182 falling under a first predetermined threshold voltage, and the control unit 188 is arranged to set the state of the switch 145 to the open state 178b as a response to the disconnect signal. This embodiment based on voltage sensing is also advantageous as the drop in the high voltage indicates the stage of the charging and, in general, the charging status of the display electrodes of the TFEL display panel 120. In the early phases of the driving pulse, when the voltage increases between a pair of segment/control electrodes during one driving pulse, a non-ideal voltage source of the high voltage node 182 has a voltage drop. The first predetermined threshold voltage can be e.g. 90% of the full level of high voltage of the high voltage node. Alternatively, the first predetermined threshold voltage can be e.g. only 10% of the full level of high voltage of the high voltage node. In this case, the supply of power to the high voltage node 182 has a very strong nonlinear behaviour, but light output is not hampered because the drop happens after a sufficient light output has occurred for each of the driving pulses supplied to the thin film electroluminescent display panel 120 for light output.

It is also possible to arrange the comparator to be based on voltage sensing of the high voltage node 182, based on the rising of the voltage of the high voltage node 182. In an embodiment, in the arrangement, the high voltage node 182 comprises a voltage. The arrangement 1 comprises a comparator unit 189 arranged to sense the voltage in the high voltage node 182 and communicate a disconnect signal to the control unit 188 through a comparator-control connection 184b as a response to voltage of the high voltage node 182 rising above a second predetermined threshold voltage, and the control unit 188 is arranged to set the state of the switch 145 to the open state 178b as a response to the disconnect signal. This embodiment based on voltage sensing is also advantageous as the rise in the high voltage also indicates the stage of the charging and, in general, the charging status of the display electrodes of the TFEL display panel 120. In the early phases of the driving pulse, when the voltage increases between a pair of segment/control electrodes during one driving pulse, a non-ideal voltage source of the high voltage node 182 has a certain rise time it is able to produce voltage to a load. The second predetermined threshold voltage can be e.g. 90% of the full level of high voltage of the high voltage node achievable to the high voltage node 182 with no load. Alternatively, the second predetermined threshold voltage can be 99% or 100% of the full level of high voltage of the high voltage node 182.

As an embodiment, in an arrangement 1, the thin film electroluminescent display panel 120 comprises one or more segment electrodes 121b and more or more common electrodes 121a. For example a simple thin film electroluminescent display panel arranged to show one number shown with a seven-segment configuration, the display panel can be arranged to comprise seven segment electrodes and one common electrode overlapping each of the segment electrodes. The driver electronics unit 140 is also arranged to generate and supply a driving signal 176 to one or more segment electrodes 121b and to one or more common electrodes 121a, as required by the number of common electrodes and segment electrodes. To facilitate the electrical connections, the arrangement 1 also comprises one or more common electrode connections 125 for connecting the one or more common electrodes 121a to the driver electronics unit 140, and one or more segment electrode connections 126 for connecting the segment electrodes 121b to the driver electronics unit 140.

As an embodiment, the switch 145 is arranged to be controlled first into the open state 178b and then to the closed state 178a during every driving pulse period 174. As another embodiment, the switch 145 is arranged to be controlled first into the open state 178b and then to the closed state 178a during a fraction of the driving pulse periods 174, e.g. after every tenth driving pulse 173. As yet another embodiment, the duration of every driving pulse period 174 is equal. In another embodiment, the duration of every driving pulse period 174 is not equal.

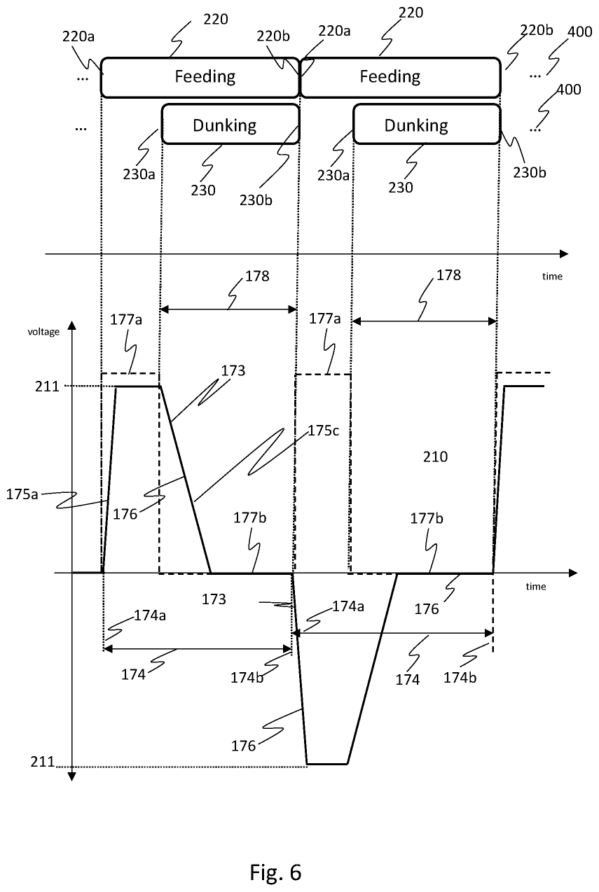

Turning to FIG. 6 and also referring back to FIGS. 4 and 5, another aspect of the invention is illustrated. FIG. 6 shows a timing diagram and a pulse diagram for a method for driving a thin film electroluminescent display with a driving signal 176 comprising driving signal voltage pulses 173. Driving signal voltage pulses 173 each have a driving pulse period 174 comprising a start 174a and an end 174b. Driving signal voltage pulses 173 are fed to a segment electrode and to a common electrode of a thin film electroluminescent display. The driving signal voltage pulses 173 are supplied with a driver electronics unit 140 connected to a high voltage node 182 with a switch 145, as shown in FIGS. 4 and 5. The method comprises the following steps a) and b):

Step a) is a feeding step 220 in which one driving signal voltage pulse 173 is fed to a segment electrode and to a common electrode of a thin film electroluminescent display. As shown in upper part of FIG. 6, the feeding step 220 comprises a start 220a of the feeding step 220 and an end 220b of the feeding step 220. The driving signal voltage pulse 173 have a driving pulse period 174 spanned by the start 220a and end 220b of the feeding step 220, respectively.

Step b) is a dunking step 230 that comprises a start 230a of the dunking step 230 in which the high voltage node 182 is disconnected from the driver electronics unit 140 with the switch 145 by setting the switch 145 to an open state, and an end 230b of the dunking step 230, in which the high voltage node is connected to the driver electronics unit 140 with the switch by setting the switch to a closed state. The start 230a of the dunking step 230 and the end 230b of the dunking step 230 span a dunking period 178. In step b), the start 230a of the dunking step 230 occurs during the driving pulse period 174, and the end of the dunking step 230b occurs at the end 220b of the feeding step 220. Both the start 230a of the dunking step 230 and the end 230b of the dunking step 230 occur during the same driving pulse period 174, that is, during the same feeding step 220.

In step b), in the start 230a of the dunking step 230, the high voltage node 182 may be specifically disconnected from the high voltage input node 143 of the driver electronics unit 140 with the switch 145 by setting the switch 145 to an open state. Also in step b), in the end 230b of the dunking step 230, the high voltage node is specifically connected to the high voltage input node 143 of the driver electronics unit 140 with the switch by setting the switch to a closed state.

Dunking means generally that something is dropped down and then brought back up, like dunking a donut into a cup of coffee. This explains the name for the dunking step in which the high voltage fed to the driver electronics unit 140, is dunked, for at least one driving pulse period or feeding step during the display operation. In an embodiment, one dunking step occurs for every feeding step. In another embodiment, one dunking step occurs for every tenth feeding step. In another embodiment, one dunking step occurs for every second feeding step.

As shown in the lower part of FIG. 6, at the start 230a of the dunking step 230, the high voltage 177a sinks to zero due to setting the switch 145 into the open state, shown at level 177b in the FIG. 6, and immediately thereafter, the voltage over the segment/common electrode pair starts to drop from a maximal value 211 along the trailing edge 175c of the pulse 173. The start 230a of the dunking step 230 can be set to occur during freely for the duration of the driving pulse period 174 as long as the desired light output is reached. The end 230b of the dunking step 230 occurs at the end 220b of the feeding step 220.

Naturally, to operate the TFEL display according to the present invention, a continuous stream of feeding steps and dunking steps are needed, marked with dotted symbol 400. As FIG. 6 also shows, a dunking step occurs concurrently with a feeding step.

In an embodiment, the start 220a of the feeding step 220, the end 220b of the feeding step 220, the start 230a of the dunking step 230 and the end 230b of the dunking step 230 are triggered by a control unit 188 (unit 188 illustrated in FIGS. 4 and 5). This is to improve the synchronous operation of the driver electronics unit 140 and the switch 145.

In another embodiment, the start 230a of the dunking step 230 is triggered by the control unit 188 after 95%, of the driving pulse period 174 has elapsed from the start 220a of the feeding step 220. If the dunking step is triggered after 95% of the driving pulse period 174 has elapsed from the start 220a of the feeding step 220, the dunking period lasts for 100%−95%=5% of the driving pulse period 174. This setting is typical for a high light output, that is, high brightness applications.

In another embodiment, the start 230a of the dunking step 230 is triggered by the control unit 188 after 5%, of the driving pulse period 174 has elapsed from the start 220a of the feeding step 220. In this case the dunking period lasts for 100%−5%=95% the driving pulse period.

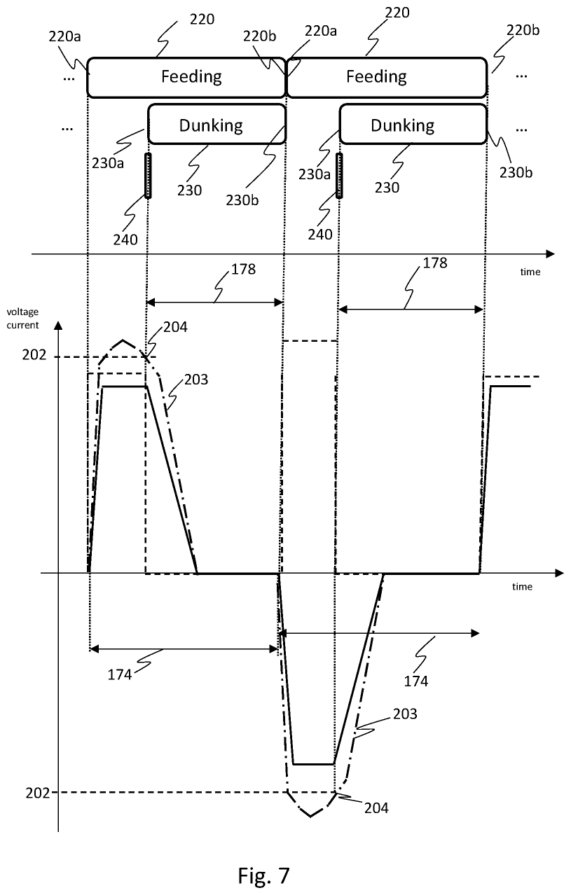

Turning to FIG. 7 and referring back also to FIG. 5, in an embodiment, the method may comprise a disconnect signal sending step 240 comprising a sending of a disconnect signal 241. The disconnect signal 241 is sent from a comparator unit 189 to the control unit 188 (signal 241 and units 188 and 189 shown in FIG. 5 but not in FIG. 7). Comparator unit 189 may be arranged to sense an input current, the time behaviour of which is shown as graph 203, from the high voltage node 182 to the driver electronics unit 140, or more specifically, to the high voltage input node 143 of the driver electronics unit 140. The disconnect signal sending step 240 may be triggered as a response to the input current 200 falling under a predetermined threshold current, marked as current level 202 in the graph of FIG. 7, moment of time marked with 204. Thereafter, the dunking step 230 may be triggered by the control unit 188 upon the control unit 188 receives a disconnect signal 241 from the comparator unit 189.

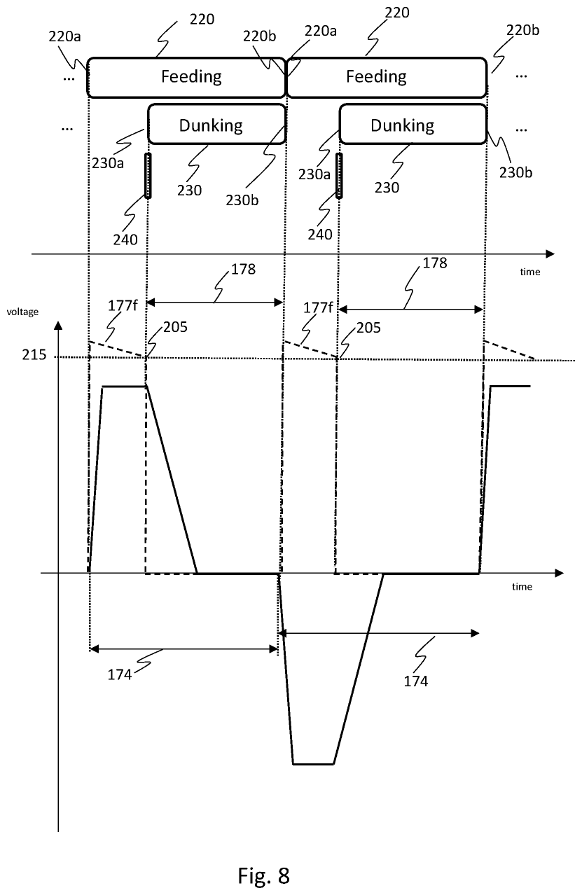

As shown in FIG. 8, it is also possible to use a comparator for the purposes of sensing the change in the voltage of the high voltage node. This is because the high voltage node 182 does not supply voltage ideally, but instead has its loading characteristics that usually cause the high voltage node 182 have a considerable drop in the voltage. Thus, in an embodiment, the method comprises a disconnect signal sending step 240 comprising a sending of a disconnect signal 241, said disconnect signal 241 sent from a comparator unit 189 to the control unit 188. The comparator unit 189 is arranged to sense the voltage 177f of the high voltage node 182, shown as a decreasing slope in FIG. 8 after the achieved peak voltage of the high voltage node 182. Disconnect signal sending step 240 is triggered as a response to the voltage of the high voltage node 182 falling under a first predetermined threshold voltage 215. In FIG. 8, these moments of time are shown with label 205. The dunking step 230 is triggered by the control unit 188 upon the control unit 188 receives a disconnect signal 241 from the comparator unit 189. The first predetermined threshold voltage 215 can be e.g. 90% of the full level of high voltage of the high voltage node. Alternatively, the first predetermined threshold voltage 215 can be e.g. only 10% of the full level of high voltage of the high voltage node. In this case, the supply of power to the high voltage node 182 has a very strong nonlinear behaviour, but light output is not hampered because the drop happens after a sufficient light output has occurred for each of the driving pulses supplied to the thin film electroluminescent display panel 120 for light output.

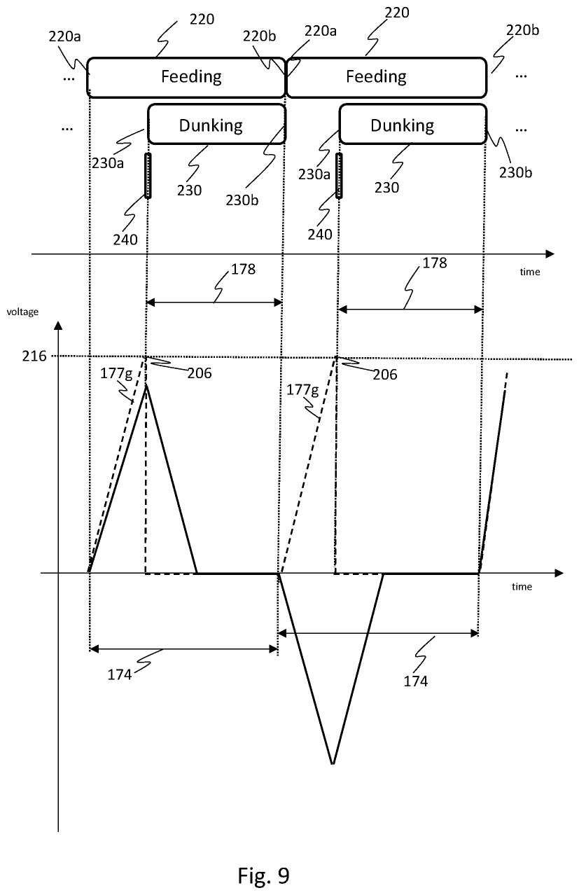

Turning to FIG. 9, it is also possible to use a comparator for the purposes of sensing the change in the voltage of the high voltage node differently as stated above in relation to FIG. 8. This is because the high voltage node 182 does not supply voltage ideally, but instead has its loading characteristics and other nonidealities that usually cause a considerable rise time to the high voltage node 182 when the load is connected to the high voltage node 182. Thus, in an embodiment, the method comprises a disconnect signal sending step 240 comprising a sending of a disconnect signal 241, said disconnect signal 241 sent from a comparator unit 189 to the control unit 188. The comparator unit 189 is arranged to sense the voltage the high voltage node 182. Disconnect signal sending step 240 is triggered as a response to the voltage of the high voltage node 182 rising above a second predetermined threshold voltage 216. In FIG. 9, these moments of time are shown with label 206. The dunking step 230 is triggered by the control unit 188 upon the control unit 188 receives a disconnect signal 241 from the comparator unit 189. The second predetermined threshold voltage 216 can be e.g. 90% of the full level of high voltage of the high voltage node. Alternatively, the second predetermined threshold voltage 216 can be e.g. 99% or 100% of the full level of high voltage of the high voltage node 182 (full level of the high voltage node 182 is the voltage achievable with no load connected to the high voltage node 182). In this case, the supply of power to the high voltage node 182 has a very strong nonideal behaviour, but light output is not hampered because the dunking period starts only after a sufficient light output has occurred for each of the driving pulses supplied to the thin film electroluminescent display panel 120 for light output.

Naturally, a feeding step can supply driving voltage pulse to one or more segment/common electrode. Thus, the in an embodiment, the feeding step 220 may comprise feeding a driving signal voltage pulse 173 having a driving pulse period 174 spanned by the start 220a of the feeding step and the end 220b of the feeding step to one or more segment electrodes 121b and to one more common electrodes 121a of the thin film electroluminescent display 100.

The invention has been described above with reference to the examples shown in the figures. However, the invention is in no way restricted to the above examples but may vary within the scope of the claims.

1. An arrangement for a thin film electroluminescent display, the arrangement comprising:
a thin film electroluminescent display panel comprising a segment electrode, a common electrode, a first insulation layer, a second insulation layer, a phosphor layer and a substrate,
a driver electronics unit arranged to generate and supply a driving signal to the segment electrode and to the common electrode,
a common electrode connection for connecting the common electrode to the driver electronics unit,
a segment electrode connection for connecting the segment electrode to the driver electronics unit,
a high voltage node arranged to provide a supply of high voltage to the driver electronics unit, the driver electronics unit comprising a high voltage input node arranged to distribute the high voltage into the driver electronics unit, wherein the arrangement comprises a switch, the switch arranged between the high voltage node and the high voltage input node of the driver electronics unit, the switch comprising two states, an open state and a closed state.

2. An arrangement according to claim 1, wherein the driving signal comprises driving signal voltage pulses and driving pulse periods, one driving signal pulse occurs during one driving pulse period and two subsequent driving signal pulses are separated in time by one driving pulse period, one driving pulse period comprising a start and an end, and the switch is arranged to be controlled during one driving pulse period
first into the open state in which the switch is arranged to disconnect the high voltage node from the high voltage input node of the driver electronics unit during the driving pulse period, and then
into the closed state in which the switch is arranged to connect the high voltage node to the high voltage input node of the driver electronics unit at the end of the driving pulse period.

3. An arrangement according to claim 2, wherein
the arrangement comprises a control unit and a switching control connection between the control unit and the switch, and
the control unit is arranged to control the switch and set the state of the switch to the open state and to the closed state through the display switching control connection.

4. An arrangement according to claim 3, wherein
the control unit is arranged into the driver electronics unit; or
the switch is arranged into the driver electronics unit; or
both the control unit and the switch are arranged into the driver electronics unit; or
the control unit is arranged external to the driver electronics unit; or
the switch is arranged external to the driver electronics unit; or
both the control unit and the switch are arranged external to the driver electronics unit.

5. An arrangement according to claim 3, wherein
the control unit comprises a timing setting unit arranged to set, to the control unit, the time the control unit sets the state of the switch to the open state during a driving pulse period.

6. An arrangement according to claim 3, wherein the arrangement comprises
a comparator unit arranged to sense an input current from the high voltage node to the high voltage input node of the driver electronics unit and communicate a disconnect signal to the control unit through a comparator-control connection as a response to the input current falling under a predetermined threshold current, and
the control unit is arranged to set the state of the switch to the open state as a response to the disconnect signal; or
the high voltage node comprises a voltage, and the arrangement comprises a comparator unit arranged to sense the voltage in the high voltage node and communicate a disconnect signal to the control unit through a comparator-control connection as a response to voltage of the high voltage node falling under a first predetermined threshold voltage, and
the control unit is arranged to set the state of the switch to the open state as a response to the disconnect signal; or
the high voltage node comprises a voltage, and the arrangement comprises a comparator unit arranged to sense the voltage in the high voltage node and communicate a disconnect signal to the control unit through a comparator-control connection as a response to voltage of the high voltage node rising above a second predetermined threshold voltage, and
the control unit is arranged to set the state of the switch to the open state as a response to the disconnect signal.

7. An arrangement according to claim 1, wherein
the thin film electroluminescent display panel comprises one or more segment electrodes and more or more common electrodes,
the driver electronics unit is arranged to generate and supply a driving signal to one or more segment electrodes and to one or more common electrodes,
and the arrangement comprises:
one or more common electrode connections for connecting the one or more common electrodes to the driver electronics unit, and
one or more segment electrode connections for connecting the segment electrodes to the driver electronics unit.

8. A method for driving a thin film electroluminescent display with a driving signal comprising driving signal voltage pulses to a segment electrode and to a common electrode of a thin film electroluminescent display, driving signal voltage pulses each having a driving pulse period, wherein the driving signal voltage pulses are supplied with a driver electronics unit connected to a high voltage node with a switch, and the method comprises:
a) a feeding step in which one driving signal voltage pulse is fed to a segment electrode and to a common electrode of a thin film electroluminescent display, the feeding step comprising a start of the feeding step and an end of the feeding step, and the driving signal voltage pulse having a driving pulse period spanned by the start of the feeding step and the end of the feeding step; and
b) a dunking step comprising a start of the dunking step in which the high voltage node is disconnected from the driver electronics unit with the switch by setting the switch to an open state, and an end of the dunking step, in which the high voltage node is connected to the driver electronics unit with the switch by setting the switch to a closed state, the start of the dunking step and the end of the dunking step spanning a dunking period, so that the start of the dunking step occurs during the driving pulse period and the end of the dunking step occurs at the end of the feeding step.

9. A method according to claim 8, wherein the start of the feeding step, the end of the feeding step, the start of the dunking step and the end of the dunking step are triggered by a control unit.

10. A method according to claim 9, wherein
the start of the dunking step is triggered by the control unit when 5% of the driving pulse period has elapsed from the start of the feeding step; or
the start of the dunking step is triggered by the control unit when 95% of the driving pulse period has elapsed from the start of the feeding step.

11. A method according to claim 9, wherein the method comprises a disconnect signal sending step comprising a sending of a disconnect signal, said disconnect signal sent from a comparator unit to the control unit, comparator unit arranged to sense an input current from the high voltage node to the driver electronics unit, disconnect signal sending step triggered as a response to the input current falling under a predetermined threshold current, the dunking step triggered by the control unit upon the control unit receives a disconnect signal from the comparator unit.

12. A method according to claim 9, wherein the method comprises a disconnect signal sending step comprising a sending of a disconnect signal, said disconnect signal sent from a comparator unit to the control unit, comparator unit arranged to sense the voltage of the high voltage node, disconnect signal sending step triggered as a response to the voltage of the high voltage node falling under a first predetermined threshold voltage, the dunking step triggered by the control unit upon the control unit receives a disconnect signal from the comparator unit.

13. A method according to claim 9, wherein the method comprises a disconnect signal sending step comprising a sending of a disconnect signal, said disconnect signal sent from a comparator unit to the control unit, comparator unit arranged to sense the voltage of the high voltage node, disconnect signal sending step triggered as a response to the voltage of the high voltage node rising above a second predetermined threshold voltage, the dunking step triggered by the control unit upon the control unit receives a disconnect signal from the comparator unit.

14. A method according to claim 8, wherein the feeding step comprises feeding a driving signal voltage pulse having a driving pulse period spanned by the start of the feeding step and the end of the feeding step to one or more segment electrodes and to one more common electrodes of the thin film electroluminescent display.
